(19) United States
(12) Patent Application Publication
(10) Pub. No.: US 2006/0080871 A1
(43) Pub. Date: Apr. 20, 2006

(54) Greeting card with integrated money value detachable section and/or insert

(76) Inventors: Pat McGoey, Oakville (CA); William Garland, Mississauga (CA)

Correspondence Address: JACOBSON HOLMAN PLLC, 400 SEVENTH STREET N.W., SUITE 600, WASHINGTON, DC, 20004, US

(21) Appl. No.: 11/204,387

(22) Filed: Aug. 16, 2005

(30) Foreign Application Priority Data
Aug. 16, 2004 (CA) 2,477,893

(51) Int. Cl. G09F 1/00

(52) U.S. Cl. 40/124.11

(57) ABSTRACT

A greeting card is comprised of a front panel and a rear panel interconnected in juxtaposition by a fold line. The front panel has a design printed on an outer surface thereof. The rear panel has a monetary value delineated section die-cut therein. The delineated section is detachably secured to the rear panel from an inner surface of the rear panel. Instructions are printed at a convenient location on the front or rear panel for the removal of the delineated section. The greeting card is dispensable in a secured manner to prevent the panels from being separated from one another along the fold line prior to the point of sale of the greeting card.

### TECHNICAL FIELD

The present invention relates to a greeting or promotional or loyalty or prepaid card, or the like, having an integrated money value detachable section and/or insert.

### BACKGROUND ART

Greeting cards are known in the art wherein the greeting card is provided with an article which is detachable or removable therefrom. An example of such greeting card is described in U.S. Pat. No. 6,640,473 wherein the greeting card is provided with a DVD which may be visible from the front panel. These greeting cards, however, can be tampered with wherein a thief can remove the DVD therefrom and leave the greeting card in a display rack. Accordingly, the sale of such greeting cards has not been successful because of this. In order to overcome this disadvantage, the greeting card with the DVD may be contained within an envelope or mailer packed in a transparent sleeve to protect the greeting card. A message card is preferably enclosed within the sleeve along with the envelope or mailer. Accordingly, the preparation of such greeting cards is fairly expensive as one has to assemble the card with a DVD attached on the back panel and then insert the card into an envelope to be sealed. The DVD can also be detached and damaged after assembly. Further, such cards cannot be used on high-speed automatic printing machines due to the nature of its insert. Again, the construction of such card is an expensive proposition.

U.S. Pat. No. 5,992,731 relates to a postcard wherein a card portion is cut out from the postcard. This card portion is meant to contain address information for the postcard and for other use after it is separated. An adhesive layer is provided to firmly hold the card portion in position during mailing of the postcard to avoid the possibility that it become separated and lost in transit. The card portion is cut out of the holding sheet at a cut line and the card portion can be used such as a telephone card. The card is provided with a magnetic strip which is protected by the lamination of the card within the postcard. This postcard is used as a mailer to solicit the use of an integrated detachable card.

### SUMMARY OF INVENTION

It is a feature of the present invention to provide a greeting card, or the like, having an integrated money value detachable section and/or insert and wherein the card is purchased at a secured point of sale and is prevented from being tampered with by intended purchasers.

Another feature of the present invention is to provide a greeting card provided with an integrated money value detachable section which is a pre-paid calling card and wherein the greeting card is suggestive of its use.

Another feature of the present invention is to provide a greeting card having an integrated money value detachable section as well as detachable postage stamps insert and wherein the card is suggested of the use of such stamps and calling card.

Another feature of the present invention is to provide a greeting card with an integrated money value detachable section and/or insert and which is secured in a tamper-proof carrier.

Another feature of the present invention is to provide a greeting card with integrated money value detachable section and/or insert and wherein the outer surface of the front panel of the greeting card is provided with printed matter suggestive of its use and wherein such printed matter also appears on the money value detachable section and/or postage stamps detachably secured from the greeting card.

According to the above features, from a broad aspect, the present invention provides a greeting card, or the like, which is comprised of a front panel and a rear panel interconnected in juxtaposition by a fold line. The front panel has a design printed on an outer surface thereof. The rear panel has a monetary value delineated section die-cut therein and retained by retention means. The delineated section is detachably secured to the rear panel from an inner surface of the rear panel. Instructions are printed at a convenient location on the front or rear panel for the removal of the delineated section from the rear panel. Securement means is provided to prevent the front and rear panels to be separated on the fold line prior to the point of sale of the greeting card.

### BRIEF DESCRIPTION OF DRAWINGS

A preferred embodiment of the present invention will now be described with reference to the accompanying drawings in which:

FIG. 1 is a perspective view of a greeting card constructed in accordance with the present invention;

FIG. 2 is an elevation view of the inner surface of the rear panel;

FIG. 3 is an elevation view showing the greeting card of FIG. 1 secured in a transparent sealed envelope;

FIG. 4 is an elevation view of the envelope of FIG. 3 as seen from its backside;

FIG. 5 is an elevation view showing a paper carrier envelope in which the greeting card of FIG. 1 may be secured;

FIG. 6 is an elevation view showing the greeting card of FIG. 1 provided with a detachable attachment strip;

FIG. 7 is a view similar to FIG. 6 but showing the securement of the front and rear panels of the greeting card being provided by a detachable tab;

FIG. 8 is an elevation view showing the inner surface of the rear panel and wherein the monetary value delineated section is a card which is laminated within the rear panel and being detached therefrom;

FIG. 9 is a rear view of FIG. 8;

FIG. 10 is a perspective view showing the greeting card provided with both a monetary value delineated section as well as detachable postage stamps insert; and

FIG. 11 is a fragmented view showing a further attachment means of the monetary value delineated section and formed integral with the rear panel.

### DESCRIPTION OF PREFERRED EMBODIMENTS

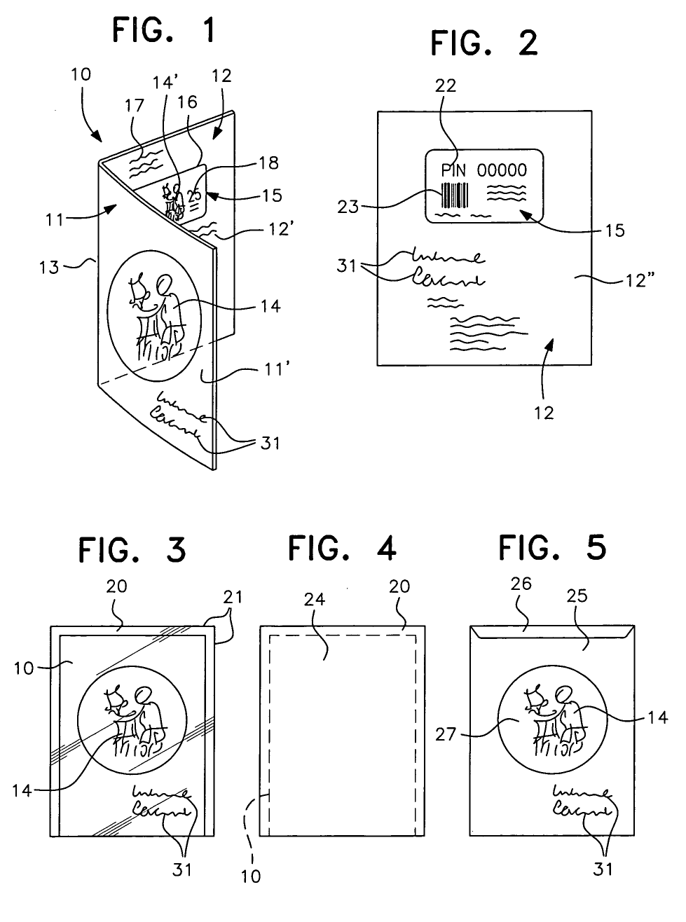

Referring now to the drawings and more particularly to FIGS. 1 and 2, there is shown generally at 10 the greeting card of the present invention. The use of the wording “greeting card” is herein intended to cover such cards as promotional cards, loyalty cards, prepaid cards, membership cards, etc. As hereinshown, it is comprised of a front panel 11 and a rear panel 12 interconnected in juxtaposition by a fold line 13. The front panel 11 has a design 14 printed on the outer surface 11′ thereof. The rear panel 12 is provided with a monetary value delineated section 15 which is die-cut therein by a contour cut line 16. This delineated section 15, which is die-cut within the rear panel, is retained by retention means as will be described later and wherein it may be detachably removed from the rear panel from the inner surface 12′ of the rear panel 12.

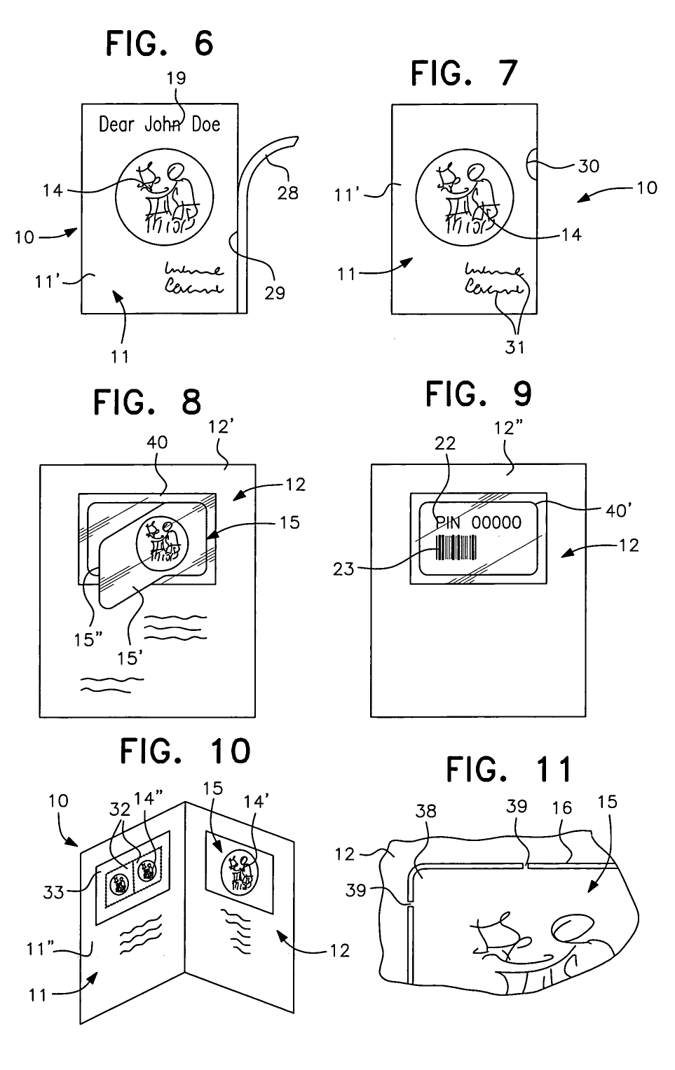

The inner surface 12′ of the rear panel is also provided with instructions 17 printed thereon, or at any convenient location of the greeting card, to provide instructions for the removal of the delineated section from the rear panel. A monetary value 18 is also printed on the delineated section and registered with a code by the provider. Accordingly, this delineated section, when removed from the rear panel, is a usable card having a predetermined pre-paid or promotional or identification value as indicated at 18. It therefore becomes necessary to provide a securement means to prevent the front and rear panels from being separated from one another along the fold line prior to the point of sale of the greeting card 10 if the greeting card is sold over the counter. However, this greeting card may have various other utility and can be personalized, as shown in FIG. 6, by addressing the card to a specific recipient whose name and address, as designated by reference numeral 19, could appear on the outer surface of the greeting card or in a mailing envelope. The monetary value delineated section 15 may be in the form of a pre-paid telephone calling card, it could also be a rebate coupon having a specific dollar value or a ticket voucher or like monetary value articles. As an example only of its use, the greeting card could be a Christmas card with ski-lift coupons detachably secured to its back panel. The coupons could also be rebates to hotel accommodations, etc.

As above-described, when the greeting card is sold over the counter, it is necessary to provide a securement means to prevent tampering. This securement means, as shown in FIGS. 3 to 5 may be constituted by envelopes. As shown in FIG. 3, the greeting card 10 is secured within a transparent sealed envelope 20 which is provided with an outer edge seal 21 thereabout. Accordingly, the greeting card 10 is rendered visible from the front and rear side of the envelope 20. If it is desirable to shield the outer surface of the rear panel 12 such as to conceal information such as a PIN number 22 or barcode 23 printed on the rear surface of the detachable card 15, as shown in FIG. 2, then the rear surface 24 of the envelope 20 may be completely opaque, or opaque in certain sections, to conceal the outer surface 12″, or parts thereof, of the rear panel 12.

In the embodiment as shown in FIG. 5, the greeting card 10 is secured within a paper envelope 25 which is sealed by a glue flap 26. That envelope would have printed matter 27 printed on a surface thereof or on opposed surfaces matching the contents of the envelope namely the greeting card 10 and informing the intended purchaser of the nature of the greeting card and its monetary value.

As shown in FIG. 6, the greeting card 10 is constructed in such a way that it need not be dispensed in a protective envelope. As shown in FIG. 6, the greeting card is herein provided with a detachable attachment strip 28. This attachment strip is constituted by edge extensions of the front and rear panels and is delineated by a perforated line 29 whereby to form a break-away strip 28.

FIG. 7 illustrates a further embodiment wherein the front and rear panels are secured together by a detachable tab 30. This detachable tab is usually removed by inserting a cutting implement between the panels and slitting it along the edge.

At a convenient location on the front or rear panel outer surfaces 11′ or 12″, there is provided printed matter such as shown at 31 which is suggested of a requested action associated with the monetary value delineated section. This suggested requested action, in the embodiment where the delineated section is a calling card, would be a recommendation to the intended recipient to use the calling card to call the person who forwarded the card. Of course, these cards are also forwarded in an appropriate envelope for mailing, if its intended use is for the purchaser to mail the card to an intended user where the card cannot be handed in person. This printed suggestive use matter 31 may also contain a suggestion that the intended user write to the sender and for this purpose, and at an appropriate location on the inner surface of the front or rear panel, there is provided postage stamps 32 such as shown in FIG. 10. For this purpose, the inner surface 11″ of the front panel 11 is provided with a silicone adhesive release patch 33 on which the postage stamps 32 are detachably secured by their glue backing. As also hereinshown, the design 14 which is printed on the outer surface 11′ of the front panel also appears on the calling card 15, as shown at 14′ and also appears on the postage stamps 32 at 14″ whereby a common theme is perpetuated throughout the greeting card and its contents and this theme is usually associated with the suggestive requested action 31 printed on the card, for example, requesting a telephone call and/or a written letter in return of reception of the greeting card.

Referring to FIGS. 8 and 9, there is shown a further construction of the rear panel 12 of the greeting card. As hereinshown, the monetary value delineated section 15 or detachable card is plasticized on both surfaces 15′ and 15″ thereof. Accordingly, a composite patch 40 and 40′ is secured about the delineated section 15 on opposed surfaces 12′ and 12″ of the rear panel whereby when the card 15 is removed from the rear panel, it is plasticized on both sides. Such lamination is known in the art, such as described in our Canadian Patent No. 2,353,283, issued Apr. 20, 2004 and entitled “INTEGRATED ELECTRONIC GIFT CARD PACKET”. Accordingly, with this lamination, the detachable card becomes wear-resistant and can be used for long periods of time.

FIG. 11 illustrates a different embodiment of the retention means whereby to retain the monetary value delineated section 15. As hereinshown the die-cut line 16 is provided with retention tabs 39 at convenient locations thereabout so that the card is removed by grasping a corner 38 thereof and lifting it out of the rear panel 12 by breaking the tabs 39.

It is within the ambit of the present invention to cover any obvious modifications of the preferred embodiment described herein provided such modifications fall within the scope of the appended claims.

1. A greeting card comprising a front panel and a rear panel interconnected in juxtaposition by a fold line, said front panel having a design printed on an outer surface thereof, said rear panel having a monetary value delineated section die-cut therein and retained by retention means, said delineated section being detachably secured to said rear panel from an inner surface of said rear panel, instructions printed at a convenient location on said front or rear panel for the removal of said delineated section from said rear panel, and means to prevent said front and rear panels to be separated on said fold line prior to the point of sale of said greeting card.

2. A greeting card as claimed in claim 1 wherein said means is a sealed envelope containing said greeting card.

3. A greeting card as claimed in claim 2 wherein said sealed envelope is a transparent sealed envelope to provide visual access to said greeting card.

4. A greeting card as claimed in claim 2 wherein said sealed envelope has a transparent front panel and an opaque rear panel, said greeting card front panel outer surface being visible through said transparent front panel and said greeting card rear panel being concealed by said greeting card rear panel.

5. A greeting card as claimed in claim 2 wherein said sealed envelope is a paper envelope having an image printed thereon representative of said greeting card and/or parts thereof.

6. A greeting card as claimed in claim 1 wherein said means is a tab or attachment strip securing said front panel to said rear panel, said tab or strip being detachable to disconnect said front panel from said rear panel for access to said monetary value delineated section.

7. A greeting card as claimed in claim 1 wherein said design printed on said outer surface has printed matter suggestive of a requested action.

8. A greeting card as claimed in claim 1 wherein said monetary value delineated section is a pre-paid telephone calling card detachable from said inner surface of said rear panel.

9. A greeting card as claimed in claim 8 wherein said telephone calling card has instructions and a PIN number and/or barcode printed on a rear face thereof, said rear face being a portion of an outer surface of said rear panel.

10. A greeting card as claimed in claim 1 wherein said monetary value delineated section is at least one of a pre-paid telephone calling card, a rebate coupon, a ticket voucher, or the like monetary value article.

11. A greeting card as claimed in claim 10 wherein said monetary value delineated section is secured to said rear panel by retention tabs of a contour die-cut line.

12. A greeting card as claimed in claim 10 wherein said monetary value delineated section is secured to said rear panel by a pressure release adhesive retaining said cut delineated section over a silicon film secured over and about said delineated section on an outer surface of said rear panel.

13. A greeting card as claimed in claim 7 wherein said printed matter also contains personalized information, such as the name of a person.

14. A greeting card as claimed in claim 7 wherein said suggestive requested action is one of demanding a telephone call or a written letter.

15. A greeting card as claimed in claim 14 wherein said delineated section is a pre-paid telephone calling card, there further being provided postage stamps detachably secured to one of said inner surfaces of said rear panel or front panel.

16. A greeting card as claimed in claim 15 wherein said stamps have an image printed thereon similar to said design printed on said outer surface of said front panel, said pre-paid telephone calling card also having a similar image printed on said inner surface of said rear panel in said delineated section.

17. A greeting card as claimed in claim 1 wherein there is further provided on an outer surface of said rear panel printed matter suggestive of a requested action, such as requesting a telephone call or a letter.

18. A greeting card as claimed in claim 1 wherein said panel having a monetary value delineated section is laminated on opposed surfaces thereof with a clear plasticized film material whereby to form a detachable card which is wear-resistant.
